(19) United States
(12) Patent Application Publication
(10) Pub. No.: US 2006/0158392 A1
(43) Pub. Date: Jul. 20, 2006

(54) Two-part driver circuit for organic light emitting diode

(75) Inventors: Wen Ching Liao, Hsin Tien (TW); Chi Chang Chen, Taoyuan City (TW)

Correspondence Address: BACON & THOMAS, PLLC, 625 SLATERS LANE, FOURTH FLOOR, ALEXANDRIA, VA, 22314, US

(73) Assignee: Princeton Technology Corporation, Hsin Tien (TW)

(21) Appl. No.: 11/037,009

(22) Filed: Jan. 19, 2005

(51) Int. Cl. G09G 3/30

(52) U.S. Cl. 345/76

(57) ABSTRACT

The present invention provides an improvement of a two-part driver circuit designed for achieving the stability of the intensity of an OLED panel. A pre-charge circuit and a constant current circuit are added before a MOS driver of an OLED panel, and a switch is used to select the pre-charge circuit or the constant current circuit for driving a gate of the MOS driver. At the beginning the pre-charge circuit is selected for driving the gate of the MOS driver, and then the swich will be switched to select the constant current circuit for driving the gate of the MOS driver.

### FIELD OF THE INVENTION

The present invention relates to an improvement of the intensity of organic light emitting diode (OLED) panel, and more particularly to a two-part driver circuit designed for achieving the stability of the intensity of an OLED panel.

### BACKGROUND OF THE INVENTION

A conventional driver circuit for an organic light emitting diode (OLED) display panel is shown in FIG. 1, which partially shows an 8×3 OLED matrix. A constant-current source I_{SEG} is connected to eight arrays of OLED via the switches SEG1, SEG2, . . . SEG8 respectively. The eight arrays of OLED are arranged into three columns and connected to the resistors R1, R2, R3 (which are resistances of the circuit, not real resistors) and the switches COM1, COM2, COM3 respectively, and finally connected to ground.

For example, when the switches COM1, SEG1 and SEG3 are connected in a closed circuit, and other switches are disconnected, current will flow through OLED 11 and OLED 31 so that OLED 11 and OLED 31 will be ON, however, the rest OLEDs will be OFF.

The more current flows through the OLED, the brighter the OLED will be. When currents flow through several OLEDs in a longitudinal column and then flow through the resistors R1, R2 or R3, it will cause multiple voltage drops across the resistors R1, R2 or R3. Thus, the voltage of the OLED and the current source will be decreased more or less, which further leads to current decrease, so that the brightness of the OLED will decrease and become unstable.

Referring to FIG. 2, which shows the equivalent circuit of an OLED driver circuit. The OLED 20 comprises a diode D21 and a resistor R22 connected serially, and a capacitor C23 is parallelly connected with the diode D21. The driver MOS 24 acts as the function of I_{SEG} and switch SEGX.

Referring to FIG. 3, which shows schematically the relationship between current “I” and time “T” of the OLED driver circuit in FIG. 2. In order to charge the capacitor C23 rapidly, the initial current must be increased rapidly, as shown in FIG. 3 of the rapid rising curve (pre-charge period). After the capacitor C23 is charged and is saturated, the current I will be gradually decreased to a constant current (constant current period) and make the OLED lighting.

When currents flow through several OLEDs in a longitudinal column and then flow through the resistors R1, R2 or R3, it will cause multiple voltage drops across the resistors R1, R2 or R3. Thus, the voltage of the OLED and the current source will be decreased more or less, which further leads to current decrease, so that the brightness of the OLED will decrease and become unstable.

In addition, due to human's visual persistence, the brightness of OLED sensed by human is a combinational effect caused by the current in pre-charge period and the current in constant current period in FIG. 3. When multiple currents flow through the resistors R1, R2 or R3, the brightness of the OLED will decrease. A conventional method to improve the brightnees of the OLED is to speed up the charging rate of the pre-charge period to shorten the pre-charge period so as to make human feel that the brightnees of OLED is not changed.

The circuit for the conventional improving method is shown in FIG. 4. An adjusting circuit is added before the gate of the driver MOS 24, as shown at the left part in FIG. 4, which comprises a MOS 41, a capacitor 42, variable resistors 43 and 44, connected as shown in FIG. 4. A control signal SW 45 is inputted into the gate of MOS 41 to make MOS 41 conducting, so as to generate voltage difference between the two input terminals of a comparator 46, and make the comparator 46 output signal to drive the signal processing circuit 47, and finally generate a PWM (Pulse Width Modulation) signal to drive the gate of MOS 24, make MOS 41 conducting, thus current will flow into OLED 20, and make the OLED lighting. The variable resistors 43 and 44 are adjustable so as to change the width of the PWM signal and the pre-charge period in FIG. 3, therefore the brightness of the OLED 20 can be adjusted.

However, the above method to change the pre-charge period in FIG. 3 has disadvantage in that if the capacitance of C23 in OLED 20 is too high, then the time for the current to decrease to constant current is too long, therefore the brightness of OLED cannot be controlled very well, and the problem that currents flow through resistors R1, R2 or R3 to decrease the brightness of OLED is still existed.

### SUMMARY OF THE INVENTION

It is therefore an object of the present invention to provide an improvement of a two-part driver circuit designed for achieving the stability of the intensity of an OLED panel.

An pre-charge circuit and a constant current circuit are added before the MOS driver of an OLED panel; a switch is used to select the pre-charge circuit or the constant current circuit for driving the gate of the MOS driver; at the beginning the pre-charge circuit is selected for driving the gate of the MOS driver, and then the swich will be switched to select the constant current circuit for driving the gate of the MOS driver.

The pre-charge circuit is a current mirror circuit, which comprises of two columns of MOS device, one column of MOS device is serially connected with a first variable resistor, while the other column of MOS device provides an output voltage, the output voltage is controlled by adjusting the resistance of the first variable resistor.

The resistance of the first variable resistor is adjusted so that the MOS driver works in its saturation region during the pre-charge period, and let the current of the MOS driver stable quickly to light the OLED. The pre-charge period is maintained as a constant period.

The constant current circuit is a current mirror circuit comprising of two columns of MOS device. One column of MOS device is serially connected with a second variable resistor, while the other column of MOS device provides an output voltage, the output voltage is controlled by adjusting the resistance of the second variable resistor.

The resistance of the second variable resistor is adjusted so that the MOS driver works in its saturation region during the constant current period, and let the current of the MOS driver stable quickly to light the OLED.

### BRIEF DESCRIPTION OF THE DRAWINGS

FIG. 1 shows a conventional driver circuit for an OLED display panel.

FIG. 2 shows the equivalent circuit of the OLED driver circuit.

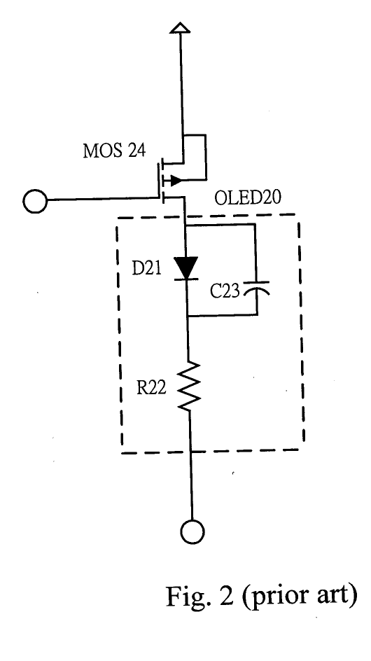

FIG. 3 shows a schematic diagram illustrating the relationship between current “I” and time “T” of the OLED driver circuit in FIG. 2.

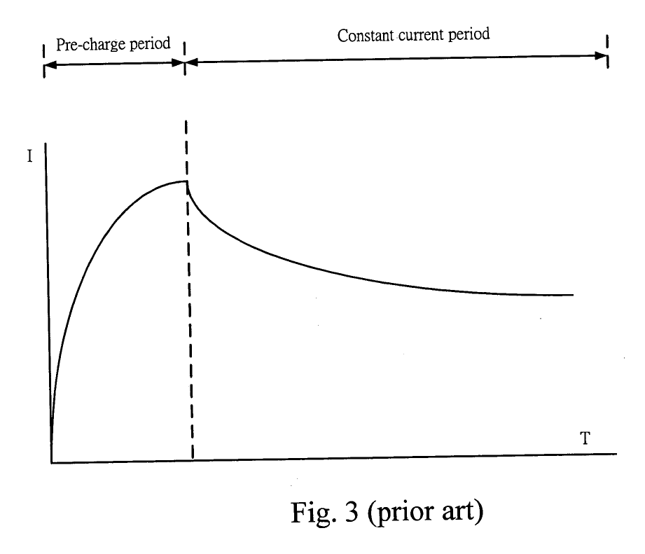

FIG. 4 shows schematically a conventional circuit for improving the stability of brightness in an OLED display panel.

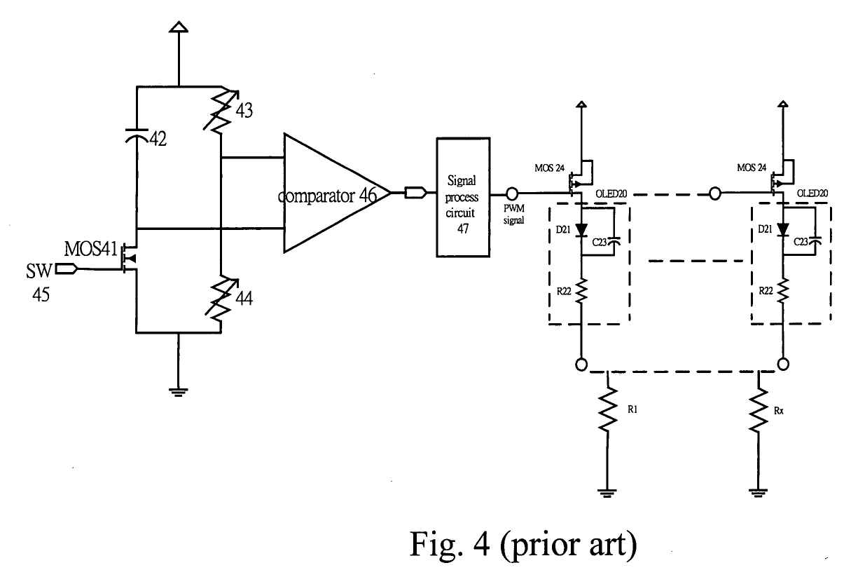

FIG. 5 shows a block diagram according to the present invention.

FIG. 6 shows a circuit according to the present invention.

FIG. 7 shows a schematic diagram illustrating the relationship between current “I” and time “T” of the OLED according to the two-part driver circuit of the present invention.

### DETAILED DESCRIPTION OF THE EMBODIMENT

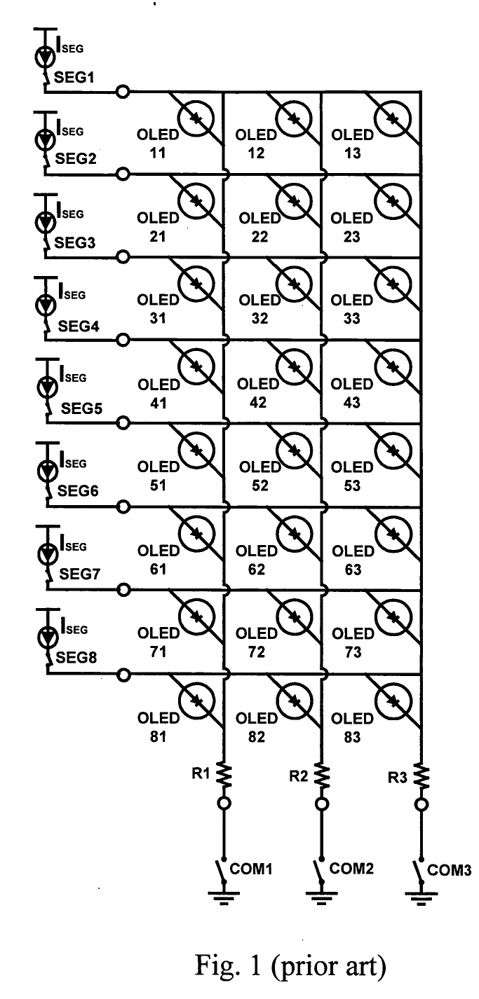

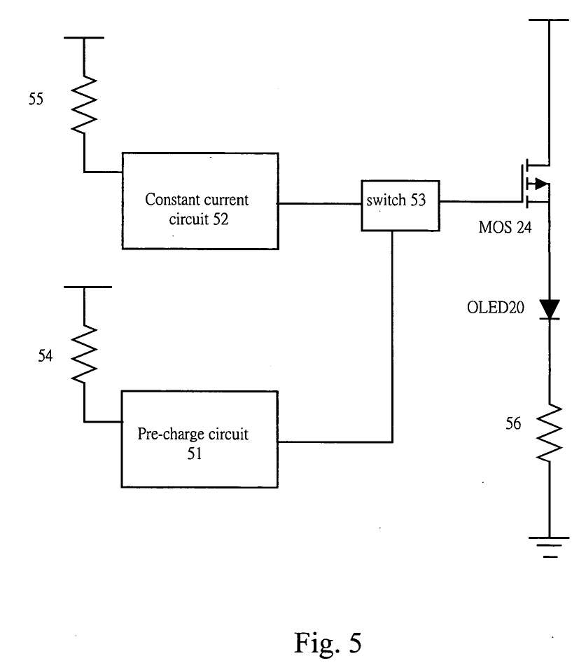

Referring to FIG. 5, which shows a block diagram according to the present invention. An pre-charge circuit 51 and a constant current circuit 52 are added before the driver MOS 24 for providing driving voltage respectively during pre-charge period and constant current period, while a switch 53 is provided for switching between the pre-charge circuit 51 and the constant current circuit 52. Variable resistor 54, 55 are used respectively for adjusting the gate voltage of the driver MOS 24. Then MOS 24 will drive OLED 20 for lighting. A resistor 56 is connected with OLED 20, and has the same function as the resistors R1, R2, R3 in FIG. 1.

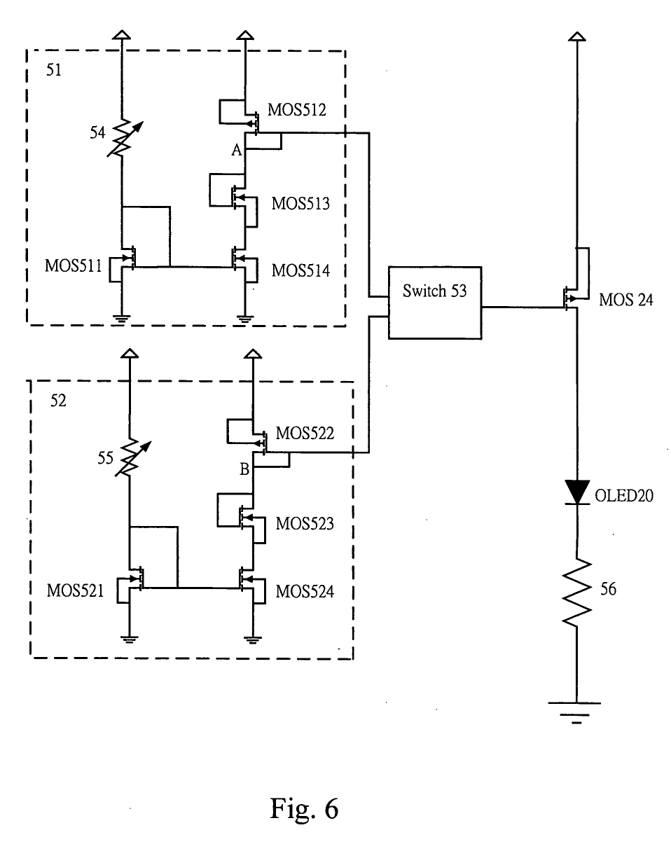

Referring to FIG. 6, which shows the details of the pre-charge circuit 51 and the constant current circuit 52 according to the present invention.

The pre-charge circuit 51 is a current mirror circuit comprising MOS 511, 512, 513 and 514 connected as shown in the Figure. The resistance of the variable resistor 54 can be adjusted so as to adjust the current in MOS 511 as well as the currents in MOS 512, 513 and 514 (due to the current mirror circuit). The voltage at point A is connected to the gate of MOS 512 for driving the gate of MOS 24. The voltage at point A is adjusted by adjusting the resistance of the resistor 54 and is inputted to the gate of MOS 24 to control the current in MOS 24.

The constant current circuit 52 is also a current mirror circuit comprising MOS 521, 522, 523 and 524 connected as shown in the Figure. The resistance of the variable resistor 55 can be adjusted so as to adjust the current in MOS 521 as well as the currents in MOS 522, 523 and 524 (due to the current mirror circuit). The voltage at point B is connected to the gate of MOS 522 for driving the gate of MOS 24. The voltage at point B is adjusted by adjusting the resistance of the resistor 55 and is inputted to the gate of MOS 24 to control the current in MOS 24.

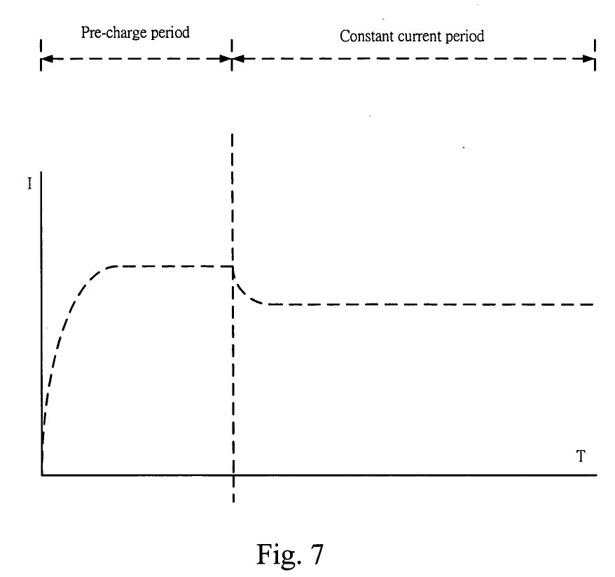

Referring to FIG. 7, which shows a schematic diagram illustrating the relationship between current “I” and time “T” of the OLED according to the two-part driver circuit of the present invention. The current in the pre-charge period is not so high as the prior art, but still can light the OLED. The pre-charge period is maintained as a constant period so that the middle part and the latter part of the pre-charge period will also maintained of a constant current, this is an effect due to the adjustment of the resistance of the variable resistor 54, which causes the MOS 24 working in its saturation region. Therefore, even if currents flow through several OLEDs in a longitudinal column and then flow through the resistor 56 (same function as the resistors R1, R2 or R3 in FIG. 1), and cause multiple voltage drops across the resistor 56, the MOS 24 can still provide sufficient current to OLED due to the MOS 24 working in its saturation region, and the brightness of OLED will not decrease.

In the constant current period, the resistance of the variable resistor 55 is adjusted to cause the MOS 24 working in its saturation region. Therefore, even if currents flow through several OLEDs in a longitudinal column and then flow through the resistor 56 (same function as the resistors R1, R2 or R3 in FIG. 1), and cause multiple voltage drops across the resistor 56, the MOS 24 can still provide sufficient current to OLED due to the MOS 24 working in its saturation region, and the brightness of OLED will not decrease.

In FIG. 7, since the current difference between the pre-charge period and the constant current period is not very high, the current in the pre-charge period is not so high as the prior art but still sufficient to light the OLED, and the pre-charge period is maintained as constant, the brightness of the OLED is therefore maintained stable.

The spirit and scope of the present invention depend only upon the following Claims, and are not limited by the above embodiments.

What is claimed is:

1. A two-part driver circuit for an OLED (organic light emitting diode) panel, an pre-charge circuit and a constant current circuit are added before a MOS driver of an OLED panel; a switch is used to select the pre-charge circuit or the constant current circuit for driving a gate of the MOS driver; at the beginning the pre-charge circuit is selected for driving the gate of the MOS driver, and then the swich will be switched to select the constant current circuit for driving the gate of the MOS driver.

2. The two-part driver circuit for an OLED (organic light emitting diode) panel according to claim 1, wherein the pre-charge circuit is a current mirror circuit, which comprises of two columns of MOS device, one column of MOS device is serially connected with a first variable resistor, while the other column of MOS device provides an output voltage, the output voltage is controlled by adjusting the resistance of the first variable resistor.

3. The two-part driver circuit for an OLED (organic light emitting diode) panel according to claim 1, wherein the constant current circuit is a current mirror circuit comprising of two columns of MOS device, one column of MOS device is serially connected with a second variable resistor, while the other column of MOS device provides an output voltage, the output voltage is controlled by adjusting the resistance of the second variable resistor.

4. The two-part driver circuit for an OLED (organic light emitting diode) panel according to claim 2, wherein the resistance of the first variable resistor is adjusted so that the MOS driver works in its saturation region during the pre-charge period, and let the current of the MOS driver stable quickly to light the OLED, and an pre-charge period is maintained as a constant period.

5. The two-part driver circuit for an OLED (organic light emitting diode) panel according to claim 3, wherein the resistance of the second variable resistor is adjusted so that the MOS driver works in its saturation region during the constant current period, and let the current of the MOS driver stable quickly to light the OLED.
